(19) United States
(12) Patent Application Publication
(10) Pub. No.: US 2009/0293327 A1
(43) Pub. Date: Dec. 3, 2009

(54) GREETING CARDS WITH SECURE DISC ENCLOSURE

(76) Inventor: Aaron Polak, Hudson, OH (US)

Correspondence Address: James C. Scott;Roetzel & Andress, Suite 900, 1375 East Ninth Street, Cleveland, OH, 44114, US

(21) Appl. No.: 12/474,387

(22) Filed: May 29, 2009

Related U.S. Application Data
(60) Provisional application No. 61/057,278, filed on May 30, 2008.

(51) Int. Cl. G09F 1/00; B65D 85/57

(52) U.S. Cl. 40/124.06

(57) ABSTRACT

Greeting cards having multiple inter-connected panels and a disc, such as a compact disc (CD) or a digital video disc (DVD). The greeting card contains a first main panel and a second main panel that are connected along a fold line and an additional third panel that is connected along a fold line to the second main panel. The third panel is folded atop the second main panel and attached along three sides creating an internal enclosure within which is contained a disc. The disc is enclosed in a protective envelope. Before attaching the third panel to the second main panel, the four corners of the protective envelope are inserted into four diagonal slits contained within the second main panel in order to secure the disc within the enclosure of the greeting card. A tab is contained upon the back of the second main panel for removal of the disc. The third panel may contain a window through which a portion of the disc may be visible. When the first main panel is in a folded or closed position, it does not cover the window of the third panel entirely so that the contents of the enclosure created by the second and third panels are visible through the window.

### RELATED APPLICATIONS

This application claims priority to U.S. Provisional Patent Application No. 61/057,278 filed on May 30, 2008.

### FIELD OF THE INVENTION

The present disclosure and related inventions are in the general field of media and combined forms of media, including printed and electronic media.

### BACKGROUND OF THE INVENTION

Printed communications continue to remain viable and desirable into the “digital era”, where increasing amounts of media arc in electronic form. This co-existence of markedly different types of media and communication has resulted in combined packages which maintain the respective advantages and features of each. However, digital media is generally more valuable than printed media forms due to the cost of modem electronic devices and media and the volume and quality of content. Digital media as carried upon digital storage devices can also be quite fragile and susceptible to environmental damage and theft. Therefore, there is a need to protect and secure digital media, particularly when it is combined with printed media, and particularly when placed for retail sale.

### SUMMARY OF THE INVENTION

The greeting cards with secure disc enclosure of the present disclosure and related inventions include first and second panels that are connected together along a fold line. A third panel is connected to a side edge of the second panel along a fold line. The third panel is folded inward and is thereby disposed between the first and second panels. The third panel is secured to the second panel along at least two edges of the second panel thereby forming an enclosure between the second and third panels with an opening along the top edge of the secured second and third panels. A window is contained within the third panel through which the contents of the enclosure created by the second and third panels are visible. When the first panel is in a closed or folded position, it does not cover the window such that the contents of the enclosure created by the second and third panels arc visible through the window. The enclosure contains a disc that may be any type of CD or DVD that is contained within a protective sleeve.

### DESCRIPTION OF THE DRAWINGS

FIG. 1 is a drawing of a die cut of the greeting card/disc combination of the present invention.

FIG. 2A is a drawing of the disc within a protective envelope.

FIG. 2B is an inside view of the greeting card/disc combination of FIG. 1 without an enclosed disc.

FIG. 3 is a front view of the folded greeting card/disc combination of FIG. 1 with an enclosed disc.

FIG. 4 is a back-side view of the greeting card/DVD combination of FIG. 1.

FIG. 5 is a back-side view of the greeting card/DVD combination of FIG. 1 illustrating removal of the tab.

FIG. 6 is a back side view of the greeting card/disc combination of FIG. 1 illustrating removal of the disc from the greeting card.

FIG. 7 is a die cut of an alternate embodiment of the greeting card/disc combination of the present invention.

### DETAILED DESCRIPTION OF PREFERRED AND ALTERNATE EMBODIMENTS

The present disclosure and related inventions include novel combinations of printed media and electronic media, in exemplary forms as a card, such as a greeting card with multiple inter-connected panels and a disc, such as a compact disc (or “disk”) (“CD”) or digital video disc (“DVD”) type discs.

As referred to herein, the acronym “CD” means or refers to and includes any of a wide array of compact discs, which are optical discs or optically read discs used to store and retrieve or play digital data. CDs were originally developed for storing digital data and audio, but which is also used for data storage (CD-ROM), write-once audio and data storage (CD-R), rewritable media (CD-RW), SACD, VCD, SVCD, PhotoCD, PictureCD, CD-I, and Enhanced CD. CD-ROMs and CD-Rs are widely used technologies in the computer and entertainment media industries. The CD and its extensions have been extremely successful: in 2004, worldwide sales of CD audio, CD-ROM, and CD-R reached about 30 billion discs. By 2007, 200 billion CDs had been sold worldwide. The CD, available on the market since late 1982, remains the standard playback medium for commercial audio recordings to the present day. Standard CDs have a diameter of 120 mm and can hold up to 80 minutes of audio. There s also the Mini CD, with diameters ranging from 60 to 80 mm; they are sometimes used for CD singles, storing up to 24 minutes of audio. The disclosure and invention can be used with either of these formats.

As referred to and used herein, the acronym “DVD” means and includes “digital versatile disc” or “digital video disc” which is not a ubiquitous optical data storage format, primarily for video and digital data storage. Most DVDs are of the same dimensions as compact discs CDs, but store more than six times as much data. Other digital storage formats which are included within and referred to as DVD include: DVD-ROM has data which can only be read and not written, DVD−R and DVD+R can be written once and then function as a DVD-ROM, and DVD-RAM, DV−RW, or DVD+RW hold data than can be erased and thus re-written multiple times. DVD-Video and DVD-Audio discs respectively refer to properly formatted and structured video and audio content. Other types of DVDs, including those with video content, may be referred to as DVD-Data discs. High definition optical formats also use a disc identical in some aspects yet more advanced than a DVD, such as Blu-ray disc.

A disc, CD or DVD, is typically protected by a sleeve or package or envelope which is then inserted into a card structure. There is provided by the invention various constructs for securing the disc to the printed or paper media in order to provide a combined package, and preferably to deter or prevent theft of the disc from the combined package.

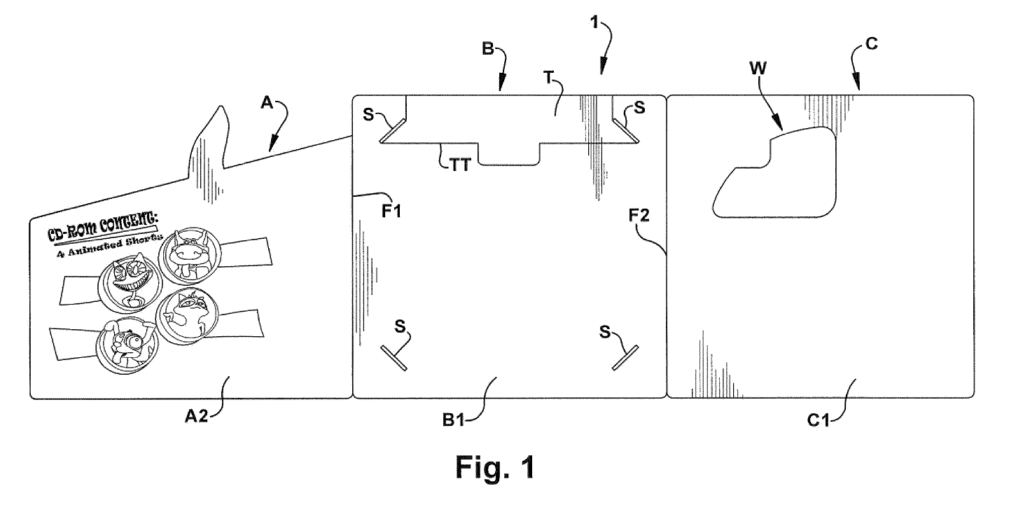

Referring now to the drawings, wherein like reference numerals designate the same or functionally similar elements throughout the several drawings and to FIG. 1 in particular, a die cut view of a greeting card with secure disc enclosure is shown having at least two panels connected together along a fold line F1. A first panel A functions as a cover and has a first page A1 (also referred to as a cover page) and an opposing second or inside page A2. A second panel B has a third page B1 which generally opposes page A2, and a fourth or back page B2.

In order to create a secure enclosure for a CD or DVD (also referred to herein as “disc D”), this particular embodiment has a third panel C connected along a fold line F2 to an edge of panel B, and folded inward to be disposed between panels A and B. Panel C is secured to page B1 of panel B along at least two edges including proximate to the fold line F1 and the bottom edge, thereby forming an enclosure between panels B and C which is closed on one side by fold F2. In other words, a fifth page C1 is secured to page B1 along two perimeters, and by fold F2. A fourth edge, for example along the top is left open for access to the enclosure and insertion and removal of a disc.

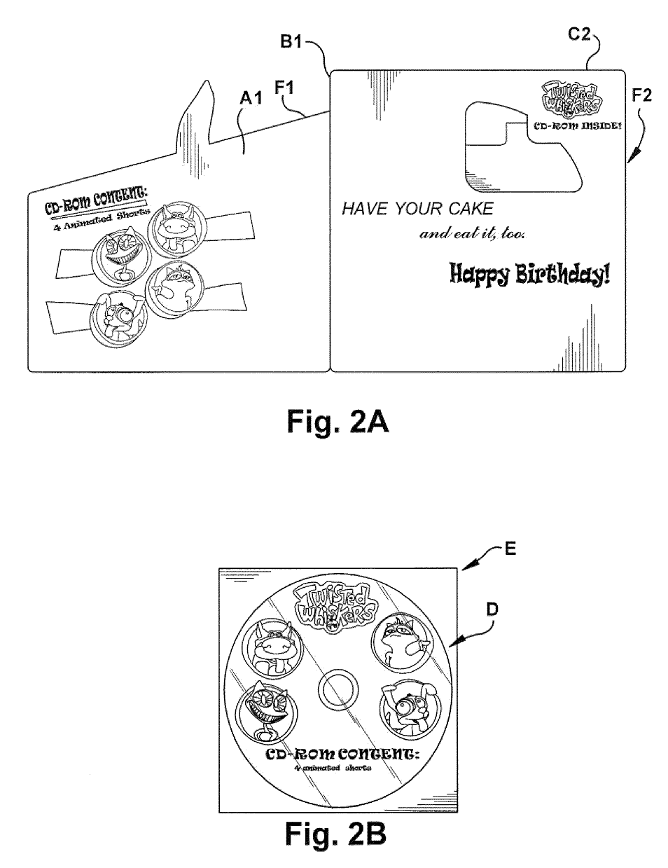

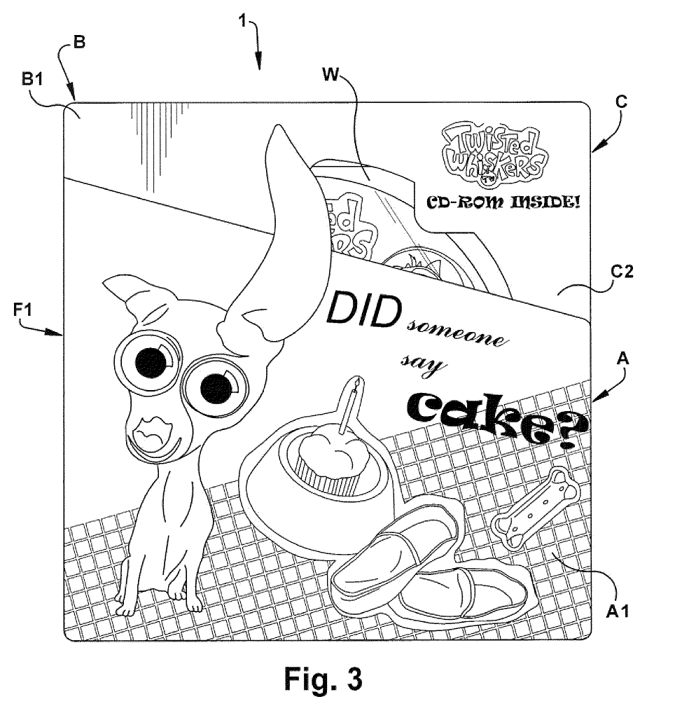

A window W (also referred to as a “cutout”) is formed in panel C, which can be in any shape or size and at any location in panel C. One example of the window being located in the upper right corner region of panel C is shown in FIG. 2A. The window W allows the contents of the enclosure between panels B and C to be visible. The disc D is inserted into a protective sleeve or envelope E that can be made of paper, plastic, or any other suitable material. The envelope will either contain a clear cover or facing or contain a circular window that allows the disc to show through the front of the envelope E, as shown in FIG. 2B. In the illustrated embodiment shown in FIG. 3 wherein panel A, when in the closed position, does not cover the entire window W, then the contents of the enclosure are visible beyond panel A, or in other words when panel A is in the closed position. This is particularly advantageous for greeting card sales, wherein cards are typically displayed in the closed condition, so that a card which carries a CD or DVD is immediately apparent as such to a consumer.

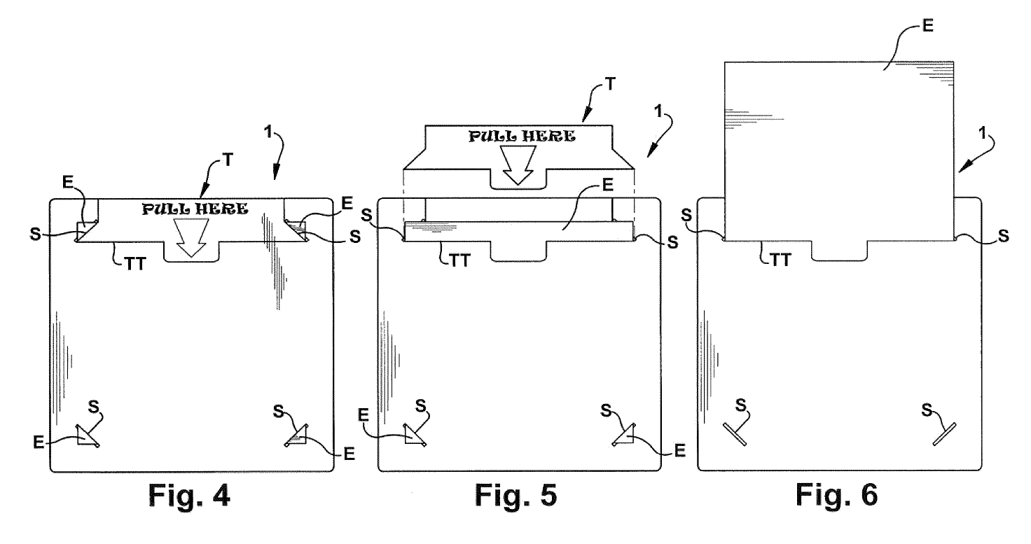

As shown in FIGS. 4 through 6, panel B2 has an additional disc gripping and enclosure structure, which may include slots S for receiving corners of an envelope E in which a disc D is enclosed, and a removable tab T, which as shown may be located proximate to an edge of panel B2, and which may work in conjunction with one or more of the slots S in panel B, and with the enclosure formed by panels B and C. The tab T is removable along tab tear lines TT, which extend to the one open perimeter between panels B and C. The size of the opening between panels B and C is smaller than that of envelope E so that the envelope E and Disc D are retained within the enclosure until the tab T is removed. The removable tab T may alternatively be located on along any edge of panel B.

By this construction, the disc D and envelope E are installed or encapsulated within the structure of the card, specifically within the enclosure formed by panels B and C, by inserting the envelope E into the holding slots S in panel B prior to attachment of panel C to panel B, or more particularly attachment 6f page C1 to page B1. By this construction and assembly, the disc D is securely encapsulated and enclosed within the card structure, and ready for handling, shipment, display stocking, and consumer inspection and purchase and delivery to a recipient all without the risk of the disk D being separated from the card. Also, the enclosure can be used to conceal an anti-theft device, such as a sensor as used in inventory control systems and/or an RF tag for product identification and automated inventory identification and control. The sensor can be installed within the enclosure by attachment to either panel B or C prior to or simultaneous with the installation of the disc. D and prior to attachment of page C1 to page B1.

As shown in FIGS. 5 and 6, once the tab T is removed, the disc D in envelope E is removable from the enclosure of panels B and C of the card.

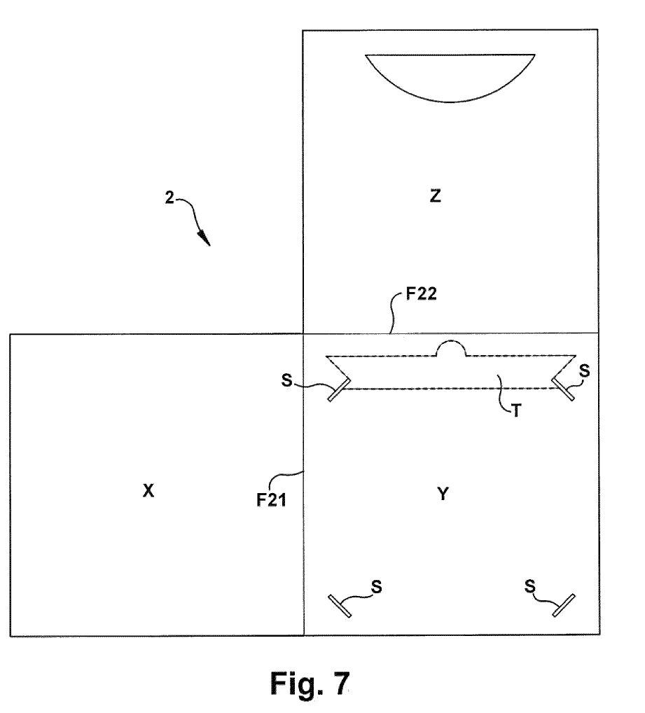

FIG. 7 illustrates an alternate embodiment of a disc-holding card, generally indicated at 2, with interconnected panels, X, Y and Z and fold lines F21 and F22. One of the panels, such as panel Z, can be configured to hold a disc within and envelope the corners of which are engaged in slots S as with the greeting card of the first embodiment. Panels X and Z are folded over the disc to form an enclosure, wherein one of the panels X or Z can be secured to panel Y to form a permanent enclosure. A removable tab T is similarly provided for access to the disc. The third panel thus provides a conventional greeting card configuration in combination with a secure disc enclosure.

These exemplary embodiments of the features and concepts of the disclosure and related inventions provide the novel combination of different types of greeting cards and one or more discs, wherein the one or more discs are securely held and even encapsulated within the card structure, while optionally being visible through one or more panels of the card, and removable from the card by opening or detachment of a pathway into the cavity or interior of the card where the disc or discs are securely held. Both forms of media are thus neatly and securely combined without risk of separation during handling and retail display.

1. A greeting card with secure disc enclosure comprising:
at least two main panels connected together along a fold line, a first panel having a first page and a second page, a second panel having a third page and a fourth page;
a third panel connected to a side edge of the second panel along a fold line wherein the third panel is folded inward to be disposed between the first and second panels and is secured to the third page of the second panel along at least two edges thereby forming an enclosure between the second and third panels and having an opening along a top edge of the secured second and third panels;
a window formed in the third panel through which the contents of the enclosure created by the second and third panels are visible;
the first panel, when in a closed position, does not cover the entire window such that the contents of the enclosure created by the second and third panels is visible through the window in the third panel when the greeting card is in a closed position; and
the enclosure contains a disc that is contained within a protective envelope containing an opening along one edge of the envelope for insertion and removal of the disc.

2. The greeting card with secure disc enclosure of claim 1 wherein the fourth page of the second panel includes four diagonal slots placed approximate to each corner of the second panel designed to receive corners of an envelope.

3. The greeting card with secure disc enclosure of claim 2 wherein the disc is placed into the protective envelope and the corners of the protective envelope are inserted into the slots located on the fourth page of the second panel before the enclosure is created by connecting the second and third panels.

4. The greeting card with secure disc enclosure of claim 1 wherein the fourth page of the second panel includes a removable tab located proximate to one edge of the second panel that is removable along a tear line and extends to an open perimeter of the enclosure located between the second and third panels.

5. The greeting card with secure disc enclosure of claim 1 wherein the size of the opening between the second and third panels is smaller than the opening in the protective envelope containing the disk.

6. The greeting card with secure disc enclosure of claim 1 wherein an anti-theft device is installed within the enclosure contained between the second and third panels.

7. The greeting card with secure disc enclosure of claim 1 wherein the disc is a DVD.

8. The greeting card with secure disc enclosure of claim 1 wherein the disc is a CD.

9. A greeting card with secure disc enclosure comprising:
at least two main panels connected together along a fold line, a first panel having a first page and a second page, a second panel having a third page and a fourth page;
a third panel connected to a side edge of the second panel along a fold line wherein the third panel is folded inward to be disposed between the first and second panels and is secured to the third page of the second panel along at least two edges thereby forming an enclosure between the second and third panels and having an opening along a top edge of the secured second and third panels;
a window is formed in the third panel through which the contents of the enclosure created by the second and third panels are visible;
the first panel, when in a closed position, does not cover the entire window such that the contents of the enclosure created by the second and third panels is visible through the window in the third panel when the greeting card is in a closed position;
the enclosure located between the second and third panels contains a disc that is contained within a protective envelope containing an opening along one of the edges of the envelope for removal of the disk;
four diagonal slots placed approximate to each corner are contained on the fourth page of the second panel; and
a tab placed proximate to one edge of the fourth page of the second panel, said tab is removable along a tear line and extends to an open perimeter of the enclosure located between panels two and three.

10. The greeting card with secure disc enclosure of claim 9 wherein the size of the opening between the second and third panels is smaller than the opening in the protective envelope containing the disk.

11. The greeting card with secure disc enclosure of claim 9 wherein an anti-theft device is installed within the enclosure contained between the second and third panels.

12. The greeting card with secure disc enclosure of claim 9 wherein the disc is a DVD.

13. The greeting card with secure disc enclosure of claim 9 wherein the disc is a CD.

14. A greeting card with secure disc enclosure comprising:
at least two main panels connected together along a fold line, a first panel having a first page and a second page, a second panel having a third page and a fourth page;
a third panel connected to a top edge of the second panel along a fold line wherein the third panel is folded downward to be disposed between the first and second panels and is secured to the third page of the second panel along at least two edges thereby forming an enclosure between the second and third panels and having an opening along a top edge of the secured second and third panels;
the enclosure located between the second and third panels contains a disc that is contained within a protective envelope, the protective envelope having an opening along one edge of the envelope for insertion and removal of the disk;
the second panel having four diagonal slots placed approximate to each corner of the second panel for receiving the four corners of an envelope; and
the second panel having a tab located proximate to one edge of the fourth page of the second panel, said tab being removable along a tear line and extending to an open perimeter of the enclosure located between the second and third panels.

15. The greeting card with secure disc enclosure of claim 14 wherein the size of the opening between the second and third panels is smaller than the opening in the protective envelope containing the disk.

16. The greeting card with secure disc enclosure of claim 14 wherein an anti-theft device is installed within the enclosure contained between the second and third panels.

17. The greeting card with secure disc enclosure of claim 14 wherein the disc is a DVD.

18. The greeting card with secure disc enclosure of claim 14 wherein the disc is a CD.

19. The greeting card with secure disc enclosure of claim 14 wherein the first, second and third panels are square shaped.

20. The greeting card with secure disc enclosure of claim 14 wherein the first panel, when in a closed position, covers the entire second panel.
